(19) United States
(12) Patent Application Publication
(10) Pub. No.: US 2016/0311102 A1
(43) Pub. Date: Oct. 27, 2016

(54) ROTARY HAMMER

(71) Applicant: Milwaukee Electric Tool Corporation, Brookfield, WI (US)

(72) Inventor: Jeremy R. Ebner, Milwaukee, WI (US)

(21) Appl. No.: 15/136,078

(22) Filed: Apr. 22, 2016

Related U.S. Application Data
(60) Provisional application No. 62/151,010, filed on Apr. 22, 2015.

(51) Int. Cl. B25D 16/00; H01M 10/0525; H01M 2/10; H01M 10/04; B25D 17/02; B25D 11/12

(52) U.S. Cl. CPC B25D 16/00; B25D 17/02; B25D 11/125; H01M 2/1022; H01M 10/0445; H01M 10/0525; B25D 2217/0007; B25D 2250/005; B25D 2250/095; H01M 2220/30

(57) ABSTRACT

A rotary hammer includes a housing, a battery pack removably coupled to the housing, a brushless direct-current motor supported by the housing, and a spindle coupled to the motor for receiving torque from the motor. A piston is at least partially received within the spindle for reciprocation therein. An anvil is received within the spindle for reciprocation in response to reciprocation of the piston. The anvil imparts axial impacts to a tool bit in response to reciprocation of the piston. The rotary hammer also includes a bit retention assembly for securing the tool bit to the spindle. The rotary hammer is operable to produce an average long-duration power output of at least 500 Watts and to deliver at least 5 Joules of blow energy to the tool bit for each of the axial impacts.

### CROSS-REFERENCE TO RELATED APPLICATIONS

This application claims priority to co-pending U.S. Provisional Patent Application No. 62/151,010 filed on Apr. 22, 2015, the entire content of which is incorporated herein by reference.

### FIELD OF THE INVENTION

The present invention relates to rotary power tools, and more particularly to cordless rotary power tools.

### BACKGROUND OF THE INVENTION

Power tools can generally be grouped into two categories: cordless power tools and corded power tools. Conventionally, regardless of whether a power tool was a cordless power tool or a corded power tool, the power tool included a brushed-type motor (i.e., motor brushes provide an electrical connection to the rotor of the motor).

A different type of motor, brushless-type motors, have not been widely used in power tools as a result of their prohibitively high cost, design considerations necessary for motor control electronics, and difficulties associated with designing a system that is capable of delivering the performance required of a variety of different power tools.

A rotary hammer is a type of power tool that typically includes a rotatable spindle and an impact mechanism, allowing the rotary hammer to impart both rotary and impact energy to a tool bit. Rotary hammers come in a variety of sizes from smaller, generally less-powerful units to larger, generally more-powerful units. Cordless versions of the smaller rotary hammers have been developed to provide improved portability; however, cordless versions of the larger rotary hammers have not been considered feasible due to the higher power requirements of the larger rotary hammers and limitations in conventional battery and motor design.

### SUMMARY OF THE INVENTION

The invention provides, in one aspect, a rotary hammer adapted to impart axial impacts to a tool bit and including a housing, and a battery pack removably coupled to the housing. The rotary hammer also includes a brushless direct-current motor supported by the housing, and a spindle coupled to the motor for receiving torque from the motor. A piston is at least partially received within the spindle for reciprocation therein. An anvil is received within the spindle for reciprocation in response to reciprocation of the piston. The anvil imparts axial impacts to the tool bit in response to reciprocation of the piston. The rotary hammer also includes a bit retention assembly for securing the tool bit to the spindle. The rotary hammer is operable to produce an average long-duration power output of at least 500 Watts and to deliver at least 5 Joules of blow energy to the tool bit for each of the axial impacts.

The invention provides, in another aspect, a rotary hammer adapted to impart axial impacts to a tool bit having a shank with a diameter of at least 18 millimeters and a working portion extending from the shank with a diameter of at least ⅞ inches. The rotary hammer includes a housing, a battery pack removably coupled to the housing, and a brushless direct-current motor supported by the housing. The rotary hammer also includes a spindle coupled to the motor for receiving torque from the motor. A piston is at least partially received within the spindle for reciprocation therein. An anvil is received within the spindle for reciprocation in response to reciprocation of the piston. The anvil imparts axial impacts to the tool bit in response to reciprocation of the piston. The rotary hammer also includes a bit retention assembly for securing the tool bit to the spindle. A ratio of an average long-duration power output of the rotary hammer to a weight of the battery pack is at least 333.3 Watts per pound.

The invention provides, in yet another aspect, a rotary hammer adapted to impart axial impacts to a tool bit and including a housing, and a battery pack removably coupled to the housing. The rotary hammer also includes a brushless direct-current motor supported by the housing, and a spindle coupled to the motor for receiving torque from the motor. A piston is at least partially received within the spindle for reciprocation therein. An anvil is received within the spindle for reciprocation in response to reciprocation of the piston. The anvil imparts axial impacts to the tool bit in response to reciprocation of the piston. The rotary hammer also includes a bit retention assembly for securing the tool bit to the spindle. The rotary hammer is operable in a first mode to deliver at least 5 Joules of blow energy to the tool bit for each of the axial impacts and in a second mode to deliver less than 5 Joules of blow energy to the tool bit for each of the axial impacts.

Other features and aspects of the invention will become apparent by consideration of the following detailed description and accompanying drawings.

### BRIEF DESCRIPTION OF THE DRAWINGS

FIG. 1 is a side view of a rotary hammer according to an embodiment of the invention.

FIG. 2 is a cross-sectional view of a shank of a tool bit for use with the rotary hammer of FIG. 1.

FIG. 3 is a cross-sectional view of a portion of the rotary hammer of FIG. 1.

FIG. 4 is a perspective view of a battery pack for use with the rotary hammer of FIG. 1.

FIG. 5 is a top view of the battery pack of FIG. 4.

FIG. 6 is a cross-sectional view of the battery pack of FIG. 4.

FIG. 7 is a schematic of a motor control system of the rotary hammer of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

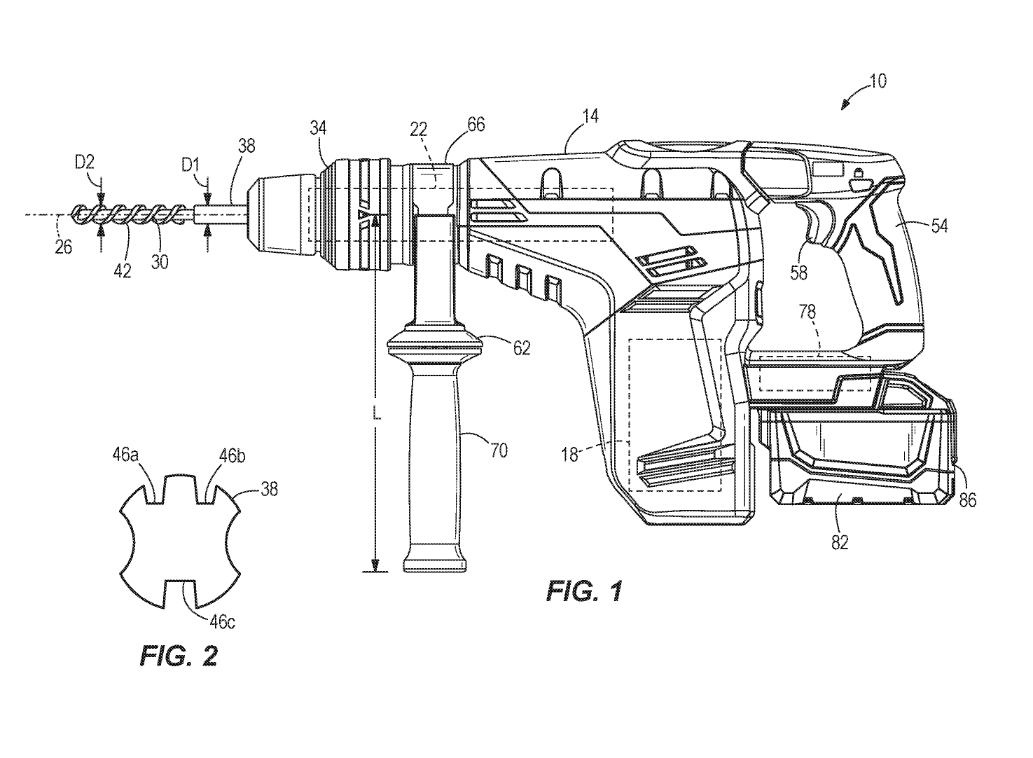

FIG. 1 illustrates a rotary hammer 10 including a housing 14, a motor 18 disposed within the housing 10, and a spindle 22 rotatable about a spindle axis 26 and coupled to the motor 18 for receiving torque from the motor 18. A tool bit 30 may be secured to the spindle 22 by a bit retention assembly 34. When secured to the spindle 22, the tool bit 30 co-rotates with the spindle 22 about the spindle axis 26. In the illustrated embodiment, the tool bit 30 has an SDS Max geometry, which has been adopted as an industry standard for some types of tool bits. The SDS Max geometry is typically used for heavy-duty work, such as chipping, chiseling, or boring large-diameter holes. The bit retention assembly 34 facilitates quick removal and replacement of different SDS Max tool bits. As such, the rotary hammer 10 may be referred to or categorized as a SDS Max rotary hammer. In other embodiments, the rotary hammer 10 may be configured to receive tool bits using a spline-fit, a hexagonal-fit, or any other suitable geometry.

With reference to FIG. 1, the tool bit 30 includes a shank 38 engageable with the bit retention assembly 34 and a work portion 42 (e.g., a cutting edge) extending from the shank 38. The shank 38 has a diameter D1 of about 18 millimeters (“mm”) and includes three grooves 46a, 46b, and 46c (FIG. 2), in accordance with the SDS Max geometry of the tool bit 30. The three grooves 46a, 46b, 46c engage with locking segments (not shown) of the bit retention assembly 34 to couple the tool bit 30 for co-rotation with the spindle 22. In some embodiments, the work portion 42 can have a diameter D2 greater than or equal to about ⅞ inches. In yet other embodiments, the work portion 42 can have a diameter D2 greater than or equal to about 1-⅛ inches. In other embodiments, the work portion 42 can have a diameter D2 between about ⅞ inches and about 1- 9/16 inches. Alternatively, the work portion 42 can have any other diameter as may be desired.

As illustrated in FIG. 1, the rotary hammer 10 further includes a main handle 54 supporting a trigger 58, and a side handle 62 that can be grasped by a user during operation of the rotary hammer 10. The side handle 62 includes a collar 66 for securing the side handle 62 to the housing 14 of the rotary hammer 10 and a fore grip 70 extending from the collar 66. In some embodiments, the side handle 62 can have a length L between about 8 inches and about 11 inches, measured from the spindle axis 26 to a bottom edge of the fore grip 70. In other embodiments, the side handle 62 can have a length L greater than or equal to about 11 inches. In the illustrated embodiment, the side handle 62 has a length of about 9.5 inches.

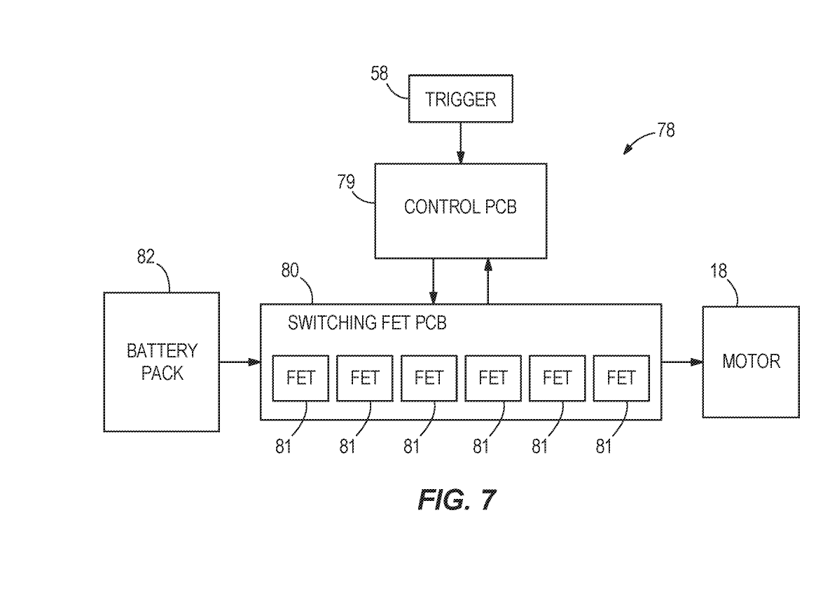

The motor 18 is a brushless direct-current (“BLDC”) motor and includes a stator (not shown) having a plurality of coils (e.g., 6 coils) and a rotor (not shown) including a plurality of permanent magnets. As shown in FIG. 7, operation of the motor 18 is governed by a motor control system 78 including a control printed circuit board (“PCB”) 79 (i.e., a “controller”) and a switching FET PCB 80 (i.e., a “switching array”).

The motor control system 78 controls the operation of the rotary hammer 10 based on sensed or stored characteristics and parameters of the rotary hammer 10. For example, the control PCB 79 is operable to control the selective application of power to the motor 18 in response to actuation of the trigger 58. The switching FET PCB 80 includes a series of switching FETs 81 for controlling the application of power to the motor 18 based on electrical signals received from the control PCB 79. The switching FET PCB 80 includes, for example, six switching FETs 81. The number of switching FETs 81 included in the rotary hammer 10 is related to, for example, the desired commutation scheme for the motor 18. In other embodiments, additional or fewer switching FETs 81 and stator coils can be employed (e.g., 4, 8, 12, 16, between 4 and 16, etc.).

The design and construction of the motor 18 is such that its performance characteristics maximize the output power capability of the rotary hammer 10. The motor 18 is composed primarily of steel (e.g., steel laminations), permanent magnets (e.g., sintered Neodymium Iron Boron), and copper (e.g., copper stator coils).

The illustrated BLDC motor 18 is more efficient than conventional motors (e.g., brush commutated motors) for rotary hammers. For example, the motor 18 does not have power losses resulting from brushes. The motor 18 also combines the removal of steel from the rotor (i.e., in order to include the plurality of permanent magnets) and windings of copper in the stator coils to increase the power density of the motor 18 (i.e., removing steel from the rotor and adding more copper in the stator windings can increase the power density of the motor 18). Motor alterations such as these allow the motor 18 to produce more power than a conventional brushed motor of the same size, or, alternatively, to produce the same or more power from a motor smaller than a conventional brushed motor for use with rotary hammers.

With reference to FIG. 1, the motor 18 receives power (i.e., voltage and current) from a battery pack 82. The battery pack 82 is removably coupled to the housing 14 of the rotary hammer 10. In the illustrated embodiment, the battery pack 82 is positioned below the main handle 54, generally adjacent the motor 18. To minimize resonance and vibration during operation of the rotary hammer 10, the battery pack 82 is optimized to be lightweight, while still providing sufficient output power and runtime. In some embodiments, the battery pack 82 has a gross weight between about 1 pound and about 2 pounds. In other embodiments, the battery pack 82 has a gross weight of about 1.5 pounds. Alternatively, multiple battery packs 82 can be electrically connected to the motor 18 such that the battery packs 82 power the motor 18 in parallel.

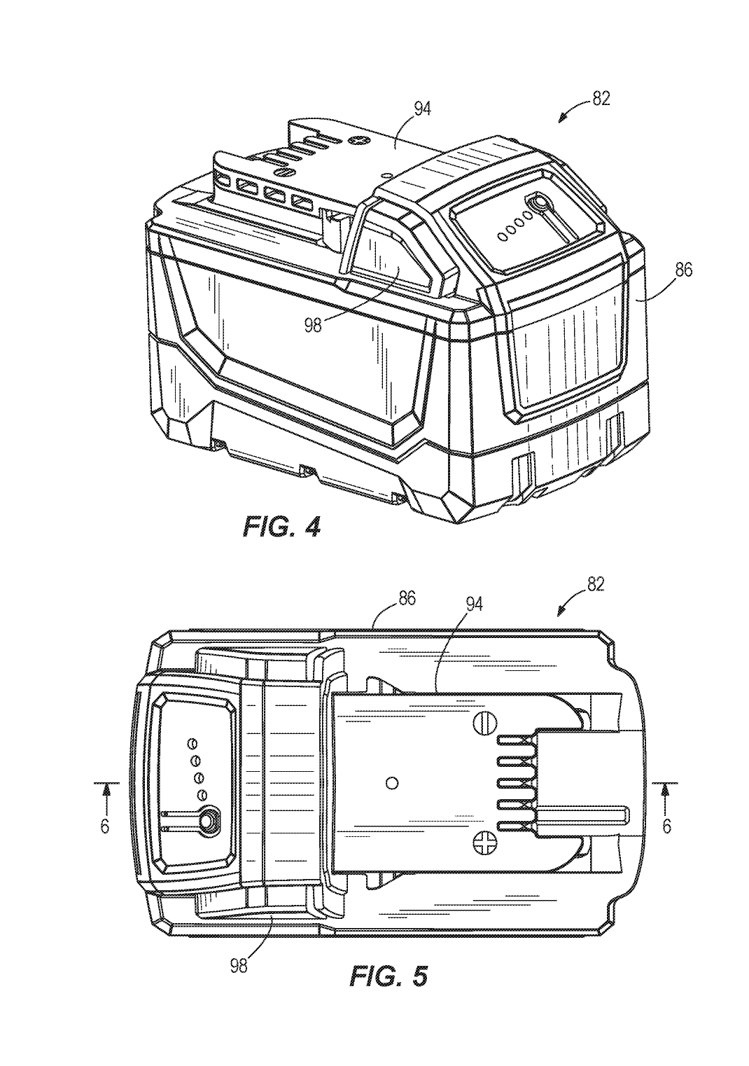

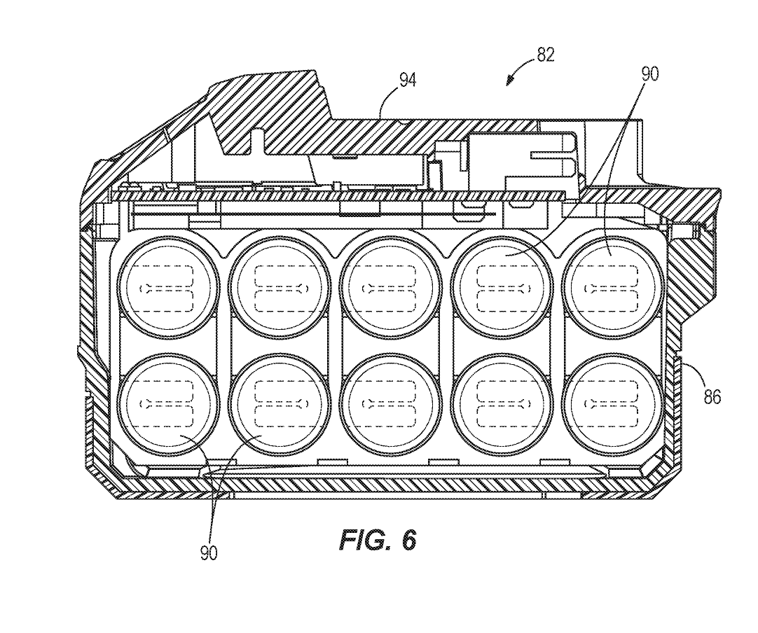

With reference to FIGS. 1 and 4-6, the battery pack 82 includes a housing 86 and a plurality of rechargeable battery cells 90 supported by the housing 86 (FIG. 6). The battery pack 86 also includes a support portion 94 for supporting the battery pack 82 on and coupling the battery pack 82 to the housing 14 of the rotary hammer 10, and a coupling mechanism 98 for selectively coupling the battery pack 82 to, or releasing the battery pack 82 from the housing 14 of the rotary hammer 10 (FIGS. 4 and 5). In the illustrated embodiment, the battery pack 82 is designed to substantially follow the contours of the rotary hammer 10 to match the general shape of the housing 14 and main handle 54 of the rotary hammer 10 (FIG. 1).

Illustrated in FIG. 6, the battery cells 90 can be arranged in series, parallel, or a series-parallel combination. For example, in the illustrated embodiment, the battery pack 82 includes a total of 10 battery cells 90 configured in a series-parallel arrangement of five sets of two series-connected cells 90. The series-parallel combination of battery cells 90 allows for an increased voltage and an increased capacity of the battery pack 82. In other embodiments, the battery pack 82 can include a different number of battery cells 90 (e.g., between 3 and 12 battery cells 90) connected in series, parallel, or a series-parallel combination in order to produce a battery pack having a desired combination of nominal battery pack voltage and battery capacity.

The battery cells 90 are lithium-based battery cells having a chemistry of, for example, lithium-cobalt (“Li—Co”), lithium-manganese (“Li—Mn”), or Li—Mn spinel. Alternatively, the battery cells 90 can have any other suitable chemistry. In the illustrated embodiment, each battery cell 90 has a nominal voltage of about 3.6V, such that the battery pack 82 has a nominal voltage of about 18V. In other embodiments, the battery cells 90 can have different nominal voltages, such as, for example, between about 3.6V and about 4.2V, and the battery pack 82 can have a different nominal voltage, such as, for example, about 10.8V, 12V, 14.4V, 24V, 28V, 36V, between about 10.8V and about 36V, etc. The battery cells 90 also have a capacity of, for example, between about 1.0 ampere-hours (“Ah”) and about 5.0Ah. In exemplary embodiments, the battery cells 90 can have capacities of about, 1.5Ah, 2.4Ah, 3.0Ah, 4.0Ah, between 1.5Ah and 5.0Ah, etc.

In some embodiments, the battery cells 90 are capable of producing an average long-run discharge current between about 10 amperes and about 40 amperes. The average long-run discharge current (or torque, output power, speed, etc.) of the battery cells 90 is the average current capable of being discharged by the battery cells 90 when the battery pack is operated through a complete discharge cycle (e.g., continuously from a fully-charged level until the battery pack 82 reaches a low-voltage cutoff). In other embodiments, the average discharge current capable of being produced by the battery cells 90 is between about 15 amperes and about 25 amperes. In yet other embodiments, the average discharge current capable of being produced by the battery cells 90 is about 20 amperes. The battery cells may also capable of higher short-run currents. In some alternative embodiments in which two battery packs 82 are electrically connected to the motor in parallel, the average discharge current capable of being produced by the battery cells 90 of each battery pack is about 20 amperes, producing a total average discharge current of about 40 amperes.

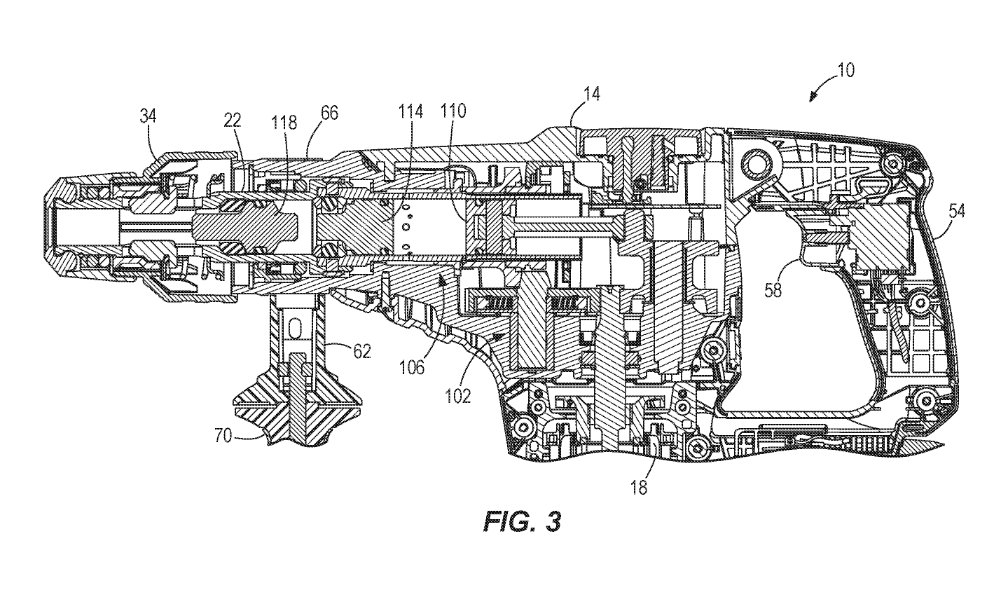

With reference to FIG. 3, the rotary hammer further includes a transmission 102 for transferring torque from the motor 18 to the spindle 22 and an impact mechanism 106 driven by the transmission 102 for delivering repeated axial impacts to the tool bit 30 for performing work on a workpiece. In the illustrated embodiment, the impact mechanism 106 includes a reciprocating piston 110 disposed within the spindle 22, a striker 114 that is selectively reciprocable within the spindle 22 in response to reciprocation of the piston 110, and an anvil 118 that is impacted by the striker 114 when the striker 114 reciprocates toward the tool bit 30. More specifically, an air pocket is developed between the piston 110 and the striker 114 when the piston 110 reciprocates within the spindle 22, whereby expansion and contraction of the air pocket induces reciprocation of the striker 114. The impact between the striker 114 and the anvil 118 is then transferred to the tool bit 30, causing it to reciprocate for performing work on the workpiece. Each of the axial impacts transfers energy from the striker 114, to the anvil 118, then to the tool bit 30, referred to herein as blow energy. The blow energy transmitted to the tool bit 30 is generally proportional to the kinetic energy of the striker 114 at the moment of impact between the striker 114 and the anvil 118. Accordingly, the blow energy can be generally represented by the following equation, where “E_{B}” is the blow energy in Joules (“J”), “mₛ” is the mass of the striker 114 in kilograms, and “vₛ” is the velocity of the striker 114 in meters per second at the moment of impact:

$${E}_{B} ∝ \frac{1}{2} {m}_{s} {v}_{s}^{2}$$

The illustrated rotary hammer 10 can include a mode switch (not shown) to toggle the rotary hammer 10 between a standard operating mode and a soft hammer operating mode. In the standard operating mode, the motor control system 78 operates the motor 18 at a first speed to drive the impact mechanism 106 and deliver a first blow energy for each impact between the anvil 118 and the tool bit 30. In the soft hammer operating mode, the motor control system 78 operates the motor 18 at a second speed, less than the first speed. This reduces the reciprocating speed of the piston 110, thereby reducing the impact velocity of the striker 114. As evident by the equation above, the reduced impact velocity of the striker 114 causes the rotary hammer 10 to deliver a second blow energy, less than the first blow energy, for each impact between the anvil 118 and the tool bit 30. Therefore, in the soft hammer mode, the rotary hammer 10 delivers a lower blow energy, which may be desirable in certain working conditions.

In some embodiments, the rotary hammer 10 is operable in the standard operating mode to deliver a blow energy greater than or equal to about 5 J and operable in the soft hammer operating mode to deliver a blow energy less than about 5 J. Alternatively, the rotary hammer 10 may not include a soft hammer operating mode. In some embodiments, the rotary hammer 10 can deliver a maximum blow energy between about 5 J and about 10 J. In yet other embodiments, the rotary hammer 10 can deliver a maximum blow energy of about 7.5 J.

The performance of a rotary hammer can be measured and evaluated in a variety of ways. For example, the performance of a rotary hammer can be evaluated using average power output (measured in Watts) of the motor of the rotary hammer, battery pack weight, battery pack voltage, blow energy, tool bit size, etc. Additionally, ratios of any one of these characteristics to any other of these characteristics can be made and are illustrative of the performance capabilities of the rotary hammer. Example performance ratios are provided below, and procedures for measuring and/or evaluating some of the noted characteristics are also provided below for the purpose of clarity.

For example, one conventional technique for determining the maximum power output of a rotary hammer and/or the maximum efficiency the rotary hammer (or motor) employs a dynamometer. The dynamometer is used to test the rotary hammer using a brake torque load (e.g., a hysteresis brake). A procedure for measuring the motor power includes attaching the rotary hammer's motor to the dynamometer, providing an input power to the motor using the battery pack or a power supply, and operating the motor under varying load conditions (i.e., levels of loading).

The capability of the rotary hammer's motor to deliver maximum continuous power is evaluated using a constant load point for the duration of the testing. However, the test can be performed multiple times at different loads in order to determine the maximum continuous output power or the approximate maximum continuous output power during the operation of the rotary hammer. In some embodiments, the fixed load point can be selected based on, for example, input current to the rotary hammer. The current load point is set to a maximum current value that does not result in a thermal failure of the rotary hammer or the battery pack, and that does not result in the rotary hammer or battery pack shutting down prematurely. In other embodiments, a load point corresponding to a specific value in units of torque, input power, or output power. Because torque is proportional to current in DC motors, both can be considered fixed to each other via a constant value. Such a test should only be considered valid if the motor of the rotary hammer or other component of the rotary hammer does not fail (e.g., thermal failure of the rotary hammer) and result in shut down prior to the natural end of battery pack discharge (e.g., as the result of one of the plurality of battery cells reaching low battery cell voltage cutoff). Such a test can be considered valid if the battery pack fails (e.g., thermal failure of the battery pack) but the rotary hammer does not fail (e.g., because of a single faulty battery cell, etc.).

The ranges provided below are for purposes of example only and are intended to be inclusive of the full range of possible values, which can vary slightly from one rotary hammer to another. For example, in some embodiments, the BLDC motor 18 of the illustrated rotary hammer 10, in combination with the battery pack 82 having a nominal voltage of 18 V, can have an average sustained power output between about 300 W and about 800 W. In other embodiments, the rotary hammer can have an average sustained power output greater than or equal to about 300 W, greater than or equal to about 350 W, greater than or equal to about 400 W, greater than or equal to about 450 W, greater than or equal to about 500 W, greater than or equal to about 550 W, greater than or equal to about 600 W, greater than or equal to about 650 W, greater than or equal to about 700 W, greater than or equal to about 750 W, or greater than or equal to about 800 W.

A ratio of the average sustained power output of a rotary hammer motor driven by a battery pack to the gross weight of the battery pack (referred to herein as a power density) can provide another performance metric for the rotary hammer. For example, in some embodiments the illustrated rotary hammer 10, in combination with the battery pack 82, having a nominal voltage of 18 V and a gross weight of 1.5 pounds, can have a power density between about 200 Watts per pound (“W/lb”) and about 533.3 W/lb. In other embodiments the rotary hammer 10 in combination with the battery pack 82 can have a power density greater than or equal to about 200 W/lb, greater than or equal to about 233.3 W/lb, greater than or equal to about 266.7 W/lb, greater than or equal to about 300 W/lb, greater than or equal to about 333.3 W/lb, greater than or equal to about 366.7 W/lb, greater than or equal to about 400 W/lb, greater than or equal to about 433.3 W/lb, greater than or equal to about 466.7 W/lb, greater than or equal to about 500 W/lb, or greater than or equal to about 533.3 W/lb.

A ratio of the blow energy of a rotary hammer driven by a battery pack to a nominal voltage of the battery pack (referred to herein as a blow energy to voltage ratio) can provide yet another performance metric for the rotary hammer. For example, in some embodiments, the rotary hammer 10 in combination with the battery pack 82 can have a blow energy to voltage ratio between about 0.28 Joules per Volt (“J/V”) and about 0.56 J/V. In other embodiments, the rotary hammer 10 can have a blow energy to voltage ratio greater than or equal to about 0.28 J/V, greater than or equal to about 0.33 J/V, greater than or equal to about 0.39 J/V, greater than or equal to about 0.44 J/V, greater than or equal to about 0.5 J/V, or greater than or equal to about 0.56 J/V.

A ratio of the blow energy of a rotary hammer driven by a battery pack to the average sustained power output of the rotary hammer motor (referred to herein as a blow energy to output power ratio) can provide still another performance metric for the rotary hammer. For example, in some embodiments, the rotary hammer 10 in combination with the battery pack 82, having a nominal voltage of 18 V, can have a blow energy to output power ratio between about 0.01 Joules per Watt (“J/W”) and about 0.035 J/W. In other embodiments, the rotary hammer 10 can have a blow energy to output power ratio greater than or equal to about 0.01 J/W, greater than or equal to about 0.015 J/W, greater than or equal to about 0.02 J/W, greater than or equal to about 0.025 J/W, greater than or equal to about 0.03 J/W, or greater than or equal to about 0.035 J/W.

A ratio of the blow energy of a rotary hammer driven by a battery pack to the gross weight of the battery pack (referred to herein as a blow energy to battery weight ratio) can provide another performance metric for the rotary hammer. For example, in some embodiments the illustrated rotary hammer 10, in combination with the battery pack 82 having a nominal voltage of 18 V and a gross weight of 1.5 pounds, can have a blow energy to battery weight ratio between about 3.3 Joules per pound (“J/lb”) and about 6.7 J/lb. In other embodiments, the rotary hammer 10 can have a blow energy to battery weight ratio greater than or equal to about 3.3 J/lb, greater than or equal to about 4.0 J/lb, greater than or equal to about 4.7 J/lb, greater than or equal to about 5.3 J/lb, greater than or equal to about 6.0 J/lb, or greater than or equal to about 6.7 J/lb.

Each of the performance metrics described above is representative of a rotary hammer (e.g., the rotary hammer 10) having a motor and battery combination capable of delivering at least 5 J of blow energy while using tool bits (e.g., SDS Max tool bits) having a working portion diameter of at least ⅞ inches.

Thus, the invention provides, among other things, a cordless SDS Max rotary hammer 10 that includes a brushless direct-current motor 18. The rotary hammer 10 is capable of producing greater blow energy and/or greater average long-duration power output compared to prior cordless rotary hammers. Although the invention has been described in detail with reference to certain preferred embodiments, variations and modifications exist within the scope and spirit of one or more independent aspects of the invention as described.

Various features of the invention are set forth in the following claims.

What is claimed is:

1. A rotary hammer adapted to impart axial impacts to a tool bit, the rotary hammer comprising:
a housing;
a battery pack removably coupled to the housing;
a brushless direct-current motor supported by the housing;
a spindle coupled to the motor for receiving torque from the motor;
a piston at least partially received within the spindle for reciprocation therein;
an anvil received within the spindle for reciprocation in response to reciprocation of the piston, the anvil imparting axial impacts to the tool bit in response to reciprocation of the piston; and
a bit retention assembly for securing the tool bit to the spindle,
wherein the rotary hammer is operable to produce an average long-duration power output of at least 500 Watts and to deliver at least 5 Joules of blow energy to the tool bit for each of the axial impacts.

2. The rotary hammer of claim 1, wherein the battery pack has a weight of about 1.5 pounds.

3. The rotary hammer of claim 1, wherein the tool bit has a SDS Max geometry.

4. The rotary hammer of claim 1, wherein the tool bit includes a shank received by the bit retention assembly and a working portion extending from the shank, and wherein the shank has a diameter of at least 18 millimeters.

5. The rotary hammer of claim 4, wherein the working portion has a diameter of at least ⅞ inches.

6. The rotary hammer of claim 5, wherein the working portion has a diameter of at least 1-⅛ inches.

7. The rotary hammer of claim 1, wherein the battery pack includes a plurality of lithium-based cells.

8. The rotary hammer of claim 7, wherein the battery pack has a nominal voltage of about 18 Volts.

9. The rotary hammer of claim 1, further comprising a motor control system including
a switching array including a plurality of switches electrically connected between the motor and the battery pack; and
a controller configured to selectively enable and disable each of the plurality of switches in the switching array to drive the motor with power provided from the battery pack.

10. The rotary hammer of claim 1, further comprising a striker received within the spindle for reciprocation in response to reciprocation of the piston, wherein the anvil is positioned between the striker and the tool bit.

11. The rotary hammer of claim 1, wherein a ratio of the average long-duration power output of the rotary hammer to a weight of the battery pack is at least 333.3 Watts per pound.

12. The rotary hammer of claim 1, wherein the rotary hammer is operable in a first mode to deliver at least 5 Joules of blow energy to the tool bit for each of the axial impacts and in a second mode to deliver less than 5 Joules of blow energy to the tool bit for each of the axial impacts.

13. A rotary hammer adapted to impart axial impacts to a tool bit having a shank with a diameter of at least 18 mm and a working portion extending from the shank with a diameter of at least ⅞ in., the rotary hammer comprising:
a housing;
a battery pack removably coupled to the housing;
a brushless direct-current motor supported by the housing;
a spindle coupled to the motor for receiving torque from the motor;
a piston at least partially received within the spindle for reciprocation therein;
an anvil received within the spindle for reciprocation in response to reciprocation of the piston, the anvil imparting axial impacts to the tool bit in response to reciprocation of the piston; and
a bit retention assembly for securing the tool bit to the spindle,
wherein a ratio of an average long-duration power output of the rotary hammer to a weight of the battery pack is at least 333.3 Watts per pound.

14. The rotary hammer of claim 13, wherein the battery pack has a weight of about 1.5 pounds.

15. The rotary hammer of claim 13, wherein the rotary hammer is operable to produce an average long-duration power output of at least 500 Watts.

16. The rotary hammer of claim 13, wherein the tool bit has a SDS Max geometry.

17. A rotary hammer adapted to impart axial impacts to a tool bit, the rotary hammer comprising:
a housing;
a battery pack removably coupled to the housing;
a brushless direct-current motor supported by the housing;
a spindle coupled to the motor for receiving torque from the motor;
a piston at least partially received within the spindle for reciprocation therein;
an anvil received within the spindle for reciprocation in response to reciprocation of the piston, the anvil imparting axial impacts to the tool bit in response to reciprocation of the piston; and
a bit retention assembly for securing the tool bit to the spindle,
wherein the rotary hammer is operable in a first mode to deliver at least 5 Joules of blow energy to the tool bit for each of the axial impacts and in a second mode to deliver less than 5 Joules of blow energy to the tool bit for each of the axial impacts.

18. The rotary hammer of claim 17, further comprising a motor control system including
a switching array including a plurality of switches electrically connected between the BLDC motor and the battery pack; and
a controller configured to selectively enable and disable each of the plurality of switches in the switching array to drive the BLDC motor with power provided from the battery pack.

19. The rotary hammer of claim 18, wherein the controller drives the BLDC motor at a first speed in the first mode of the rotary hammer, and the controller drives the BLDC motor at a second speed less than the first speed in the second mode of the rotary hammer.

20. The rotary hammer of claim 17, wherein a ratio of an average long-duration power output of the rotary hammer to a weight of the battery pack is at least 333.3 Watts per pound.
